(19) United States
(12) Patent Application Publication
(10) Pub. No.: US 2024/0345546 A1
(43) Pub. Date: Oct. 17, 2024

(54) METHOD AND SYSTEM FOR CONTROLLING A PRODUCTION SYSTEM

(71) Applicant: Siemens Aktiengesellschaft, München (DE)

(72) Inventors: Markus Kaiser, Cambridge (GB); Kai Heesche, München (DE); Stefan Depeweg, Berlin (DE)

(21) Appl. No.: 18/293,859

(22) PCT Filed: Aug. 2, 2022
(86) PCT No.: PCT/EP2022/071739

§ 371 Date: Jan. 31, 2024

(30) Foreign Application Priority Data
Aug. 6, 2021 (EP) 21190143.4

(51) Int. Cl. G05B 13/02

(52) U.S. Cl. CPC G05B 13/0265

(57) ABSTRACT

For controlling a production system product version-specific training data sets are read in for each of multiple product versions. Each training data set comprises a design data set. The design data sets are fed into a machine learning module covering all product versions. An output signal is fed into both a first product version-specific machine learning module and also a second product version-specific machine learning module. The machine learning modules are jointly trained so that output data (O1) of the first machine learning module reproduces the performance values of the first product version and output data of the second machine learning module reproduces the performance values of the second product version. Then, a plurality of synthetic design data sets are generated and fed into the trained machine learning module. The resulting output signal is fed into the trained first machine learning module. A performance-optimized design data set is derived.

### CROSS-REFERENCE TO RELATED APPLICATIONS

This application claims priority to PCT Application No. PCT/EP2022/071739, having a filing date of Aug. 2, 2022, which claims priority to European Application No. 21190143.4, having a filing date of Aug. 6, 2021, the entire contents both of which are hereby incorporated by reference.

### FIELD OF TECHNOLOGY

The following relates to a method and system for controlling a production system.

### BACKGROUND

For producing complex technical products, such as robots, motors, turbines, turbine blades, internal combustion engines, tools, motor vehicles or their components, computer-aided design systems are becoming increasingly commonly used. By these design systems, design data is usually generated, which specifies a product to be produced in detail and which can be used to control production systems for the production of the specified product.

To improve desired product characteristics, which are often expressed as the performance, in many cases the goal is to automatically optimize the design data for the product. Such a performance can relate in particular to functionality, yield, speed, weight, runtime, precision, failure rate, resource consumption, efficiency, pollutant emissions, stability, wear, service life, a physical property, a mechanical property, an electrical property, a secondary condition to be observed, or other target variables of the product.

In order to optimize the performance of a product to be produced, so-called MDO methods, or multidimensional optimization methods, are used. These MDO methods typically simulate a plurality of design variants of the product specified by design data and specifically select those that optimize a simulated performance.

However, such simulations are often considerably computationally intensive, in particular since a large number of design variants often need to be evaluated. In order to reduce the required computational effort, so-called surrogate models are often used, which are trained, in particular by machine learning methods, to predict relevant simulation results without detailed simulation. However, such surrogate models often exhibit low or variable accuracy.

### SUMMARY

An aspect relates to a method and a system for controlling a production system, which allow for more efficient design optimization.

To control a production system for producing a first product version based on design data sets of the first and a second product version, a plurality of product version-specific training data sets are read in. The training data sets each comprise a design data set specifying a design variant of a particular product version and a performance value quantifying a performance of the design variant. The design data sets are fed into a machine learning module covering all product versions. An output signal of the machine learning module covering all product versions is fed into both a first and a second product version-specific machine learning module. According to embodiments of the invention, the machine learning modules are jointly trained so that output data of the first machine learning module reproduces the performance values of the first product version and output data of the second machine learning module reproduces the performance values of the second product version. A plurality of synthetic design data sets are then generated and fed into the trained machine learning module covering all product versions. The resulting output signal of the trained machine learning module covering all product versions is fed into the trained first machine learning module. Depending on the resulting output data of the trained first machine learning module, a performance-optimized design data set is derived from the synthetic design data sets and output for the production of the first product version.

To implement the method according to embodiments of the invention, a system for controlling a production system, a computer program product (non-transitory computer readable storage medium having instructions, which when executed by a processor, perform actions) and a machine-readable, non-volatile, storage medium are provided.

In embodiments, the method according to the invention and the system according to embodiments of the invention can be embodied or implemented, for example, by one or more computers, processors, application specific integrated circuits (ASIC), digital signal processors (DSP) and/or so-called Field Programmable Gate Arrays (FPGA).

Embodiments of the invention permit the use of data from optimizations and trainings carried out for other, in particular earlier product versions, for predicting the performance of a currently to be produced first product version, as well as for optimizing it. This use of previous optimization or machine training results for a new application is often also referred to as transfer learning.

In many cases, the machine learning module covering all product versions enables interdependencies between design and performance common to different product versions to be learned very efficiently. This means that training data from previous product versions can often be used in a very advantageous way. In contrast, differences between the product versions can be taken into account by the product version-specific machine learning modules.

In this way, training efficiency can often be significantly increased, especially with similar product versions. In many cases, less training data is required for the first product version to be newly produced. In addition, an optimization speed and/or prediction accuracy can often be increased.

Embodiments and refinements of the invention are specified in the dependent claims.

According to an embodiment of the invention, a performance value for the design variant specified by the respective design data set can be determined by simulation for a plurality of design data sets. A specific design data set can then be used as a training data set together with the predicted performance value. For the determination of performance values by simulation, a plurality of efficient simulation methods are available, in particular for the mechanical, electrical and/or thermal simulation of products or their components.

According to an embodiment of the invention, first product specifications, to be fulfilled by the first product version, and second product specifications, to be fulfilled by the second product version, can be read in. During the joint training of the machine learning modules, the first product specifications can be fed into the first machine learning module, and the second product specifications can be fed into the second machine learning module. Accordingly, when the resulting output signal is fed into the trained first machine learning module, the first product specifications can also be fed into the trained first machine learning module. In this way, correlations between product specifications, design data sets and/or performance values can be modeled or learned via training and used to predict performance.

Furthermore, the product version-specific machine learning modules can each implement a linear regression model and the machine learning module covering all product versions can implement a Gaussian process. In this way, linear correlations between performance values of different product versions can be learned in an efficient manner. Since linear relationships can usually be modeled by relatively few parameters, in many cases only relatively little training data is required for training.

Alternatively, or additionally, the machine learning modules can each comprise a neural network. The machine learning module covering all product versions can be implemented in particular by a multi-layer perceptron. The product version-specific machine learning modules can each include one or more neural layers. The neural layers can also be used to efficiently learn non-linear correlations between performance values of different product versions.

According to an embodiment of the invention, multiple sets of machine learning modules can be provided, each with a machine learning module covering all product versions and at least two product version-specific machine learning modules. A number or quantity of available training data sets can also be determined. Depending on the determined number or quantity, one of the sets can then be selected for the implementation of the training and for deriving the performance-optimized design data set. In this way, depending on the number or quantity of training data available, a set of machine learning modules can be selected which is particularly suitable for this number or quantity. This could be, for example, one or more linear regression models in the event that only relatively few training data samples are available.

It is also possible to check whether product specifications are available for the first and second product versions.

In particular, it can also be checked whether the product specifications relate to product parameters common to both product versions. If the result of the test is positive, a set of machine learning modules can be selected, into the product version-specific machine learning modules of which product specifications are to be fed.

### BRIEF DESCRIPTION

Some of the embodiments will be described in detail, with references to the following Figures, wherein like designations denote like members, wherein:

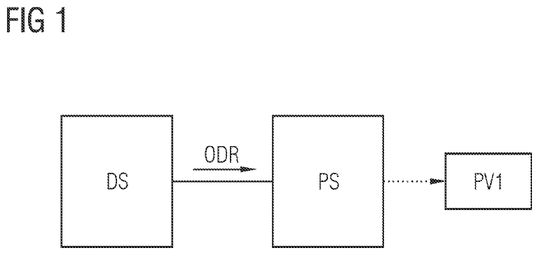

FIG. 1: shows a design system being used for controlling a production system for producing a product;

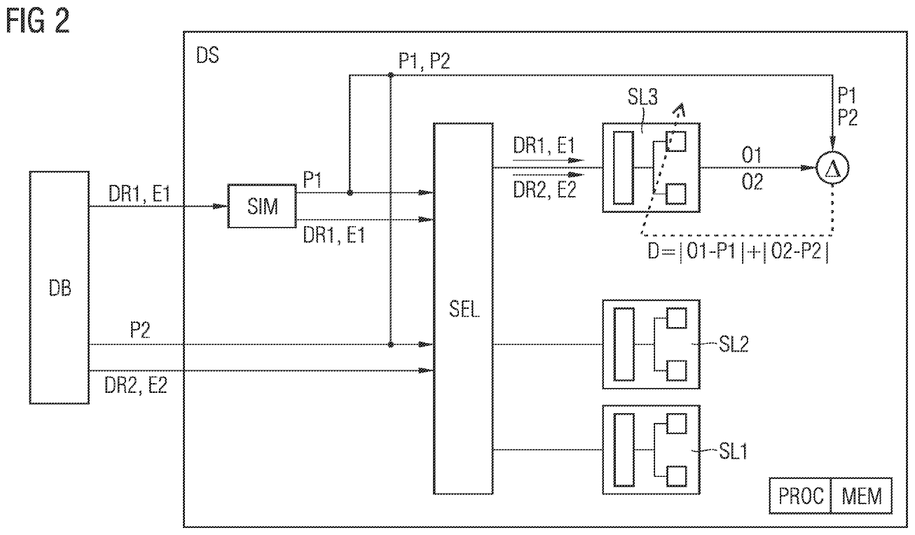

FIG. 2: shows a design system according to embodiments of the invention in a training phase:

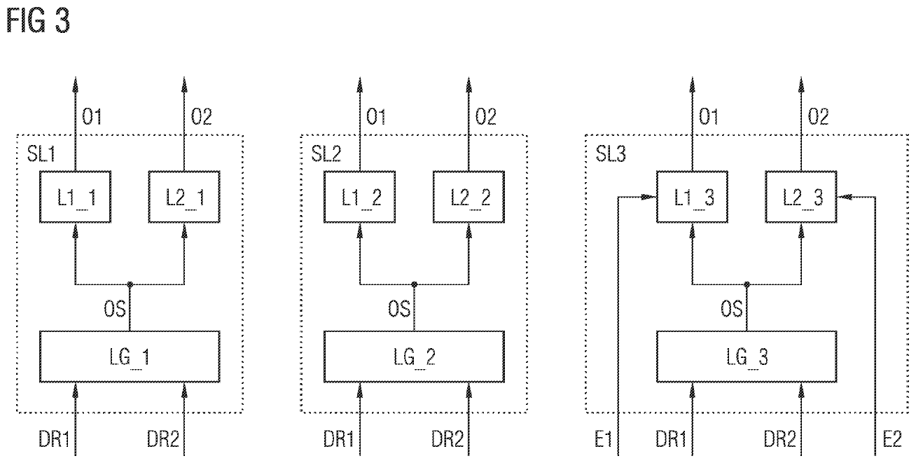

FIG. 3: shows different sets of machine learning modules; and

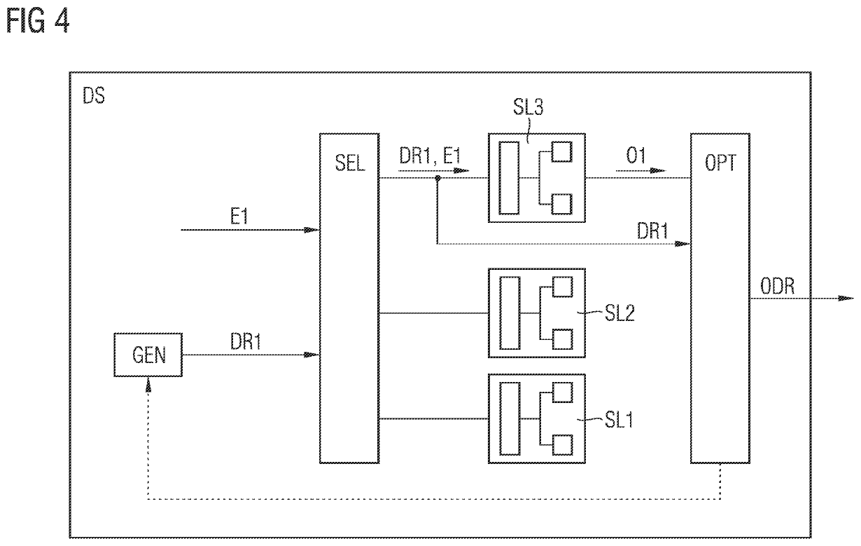

FIG. 4: shows the design system according to embodiments of the invention in an application phase.

### DETAILED DESCRIPTION

Where the same or corresponding reference signs are used in the figures, these reference signs refer to identical or corresponding entities, which may be implemented or designed in particular as described in connection with the figure in question.

FIG. 1 illustrates a design system DS coupled to a production system PS in a schematic representation. The design system DS is used for the computer-aided design of a product PV1 optimized with respect to a performance and for controlling the production system PS in order to produce the product version PV1. The production system PS may comprise a manufacturing plant, a robot, a machine tool and/or other devices for producing or processing the product PV1 or a component thereof based on design data. The product PV1 to be produced can in particular be a motor, a robot, a machine tool, a turbine blade, a wind turbine, a gas turbine, a motor vehicle or another machine, another technical structure or component of these products.

A particular design or design variant of the product version PV1 to be produced is specified by design data in the form of a respective design data set. Such a design data set may specify in particular a geometry, a structure, a property, a production step, a material and/or a component of the product version PV1.

According to embodiments of the invention, the design system DS is intended to be capable of largely automatically generating a realistic design data set ODR which is optimized with respect to a performance of the product version PV1. Optimizing as used in this application is also understood as an approximation to an optimum. In particular, the performance can relate to a functionality, yield, speed, weight, runtime, precision, failure rate, resource consumption, vibration tendency, temperature resistance, stiffness, material fatigue, efficiency, pollutant emissions, stability, wear, service life, a physical property, a mechanical property, an electrical property, a secondary condition to be observed or other target variables of the product PV1.

For the aforementioned purpose, the design system DS is trained based on available design data sets for the first product version PV1 to be produced, and additionally based on available design data sets for at least one other product version using machine learning methods—as explained in more detail below.

As a result of the optimization, the design system DS generates a performance-optimized design data set ODR and transmits this to the production system PS. Based on the performance-optimized design data set ODR, the production system PS is caused to produce a performance-optimized new product version PV1 consistent with the performance-optimized design data set ODR.

FIG. 2 illustrates a design system DS according to embodiments of the invention in a training phase. The design system DS has one or more processors PROC for implementing the method according to embodiments of the invention and one or more memories MEM for storing data to be processed.

For training the design system DS, a plurality of training data sets for the current, first product version PV1 to be produced as well as a plurality of training data sets for at least one other product version are read in or generated. The at least one other product version may in particular be an earlier version of the product to be produced, for which performance data or other empirical values are already available. For reasons of clarity, only data and processing steps for two product versions are explicitly presented and described in the figures.

The training data sets specific to the first product version PV1 each comprise a design data set DR1 specifying a design variant of the first product version PV1, and a performance value P1 quantifying the performance of the design variant. Accordingly, the training data sets specific for a second product version each comprise a design data set DR2 specifying a design variant of the second product version, and a performance value P2 quantifying the performance of the design variant.

In addition, for the first product version PV1, first product specifications E1, which must be fulfilled by the product version PV1, and second product specifications E2, which must be fulfilled by the second product version, are read in. The product version-specific product specifications E1 and E2 are predefined and, unlike the design data sets, cannot be optimized. For example, product specifications E1 and E2 can specify a product type, product geometry, product dimensions, product environment, operating environment, operating specifications, boundary conditions, secondary conditions, an installation location, an ambient temperature range, and/or other environmental data.

For the present exemplary embodiment, it is assumed that the plurality of design data sets DR1 and the product specifications E1 of the first product version PV1, as well as the plurality of design data sets DR2 with the associated performance values P2 and with the product specifications E2, are read in by the design system DS from a database DB.

The database DB contains a plurality of training data sets evaluated with respect to performance, in particular for earlier second product versions. The performance values P2 can be derived in particular from measurements on previous product versions or from simulations of these previous product versions.

It is also assumed that the design variants of the first product version PV1 specified by the design data sets DR1 do not yet have any performance specifications. For this reason, the design data sets DR1 and the product specifications E1 are fed into a simulator SIM of the design system DS. The simulator SIM is used to simulate design variants specified by the supplied design data sets, in this case DR1, and to determine by simulation the respective performance, in this case P1, of a respective design variant of the first product version PV1. To carry out such simulations, a plurality of known simulation methods or simulators for mechanical, electrical or thermal simulation are available.

The design data sets DR1 are transmitted together with the corresponding performance values P1 determined by simulation and with the product specifications E1 from the simulator SIM to a selection module SEL of the design system DS. The design data sets DR2 with the associated performance values P2 and the product specifications E2 are also fed into the selection module SEL.

Multiple sets SL1, SL2 and SL3 of machine learning modules are connected to the selection module SEL or can at least be addressed by the selection module SEL. The purpose of the selection module SEL is to select one of the sets SL1, SL2 or SL3 depending on the presence of product specifications, in this case E1, E2, and depending on the quantity or number of available training data sets. For this purpose, the number or quantity of training data sets is determined by the selection device SEL. In particular, a number or amount of training data sets with high performance values can be determined. Such training data sets are particularly relevant for an evaluation of high-performance design variants. In addition, the selection module SEL checks whether product specifications, in this case E1, E2, are available for both product versions and relate to product parameters common to both product versions.

The different sets SL1, SL2 and SL3 of machine learning modules are shown schematically in FIG. 3. In this case, set SL1 comprises a machine learning module LG_1 covering all product versions, as well as product version-specific machine learning modules L1_1 and L2_1. Accordingly, set SL2 comprises a machine learning module LG_2 covering all product versions, as well as product version-specific machine learning modules L1_2 and L2_2. Furthermore, set SL3 comprises a machine learning module LG_3 covering all product versions as well as product version-specific machine learning modules L1_3 and L2_3. The product version-specific machine learning modules L1_1, L1_2 and L1_3 are assigned to the first product version PV1, while the product version-specific machine learning modules L2_1, L2_2 and L2_3 are assigned to the second product version.

If selected, a respective set SL1, SL2 or SL3 is intended to be trained, based on design data sets supplied, to predict the performance of a first product version PV1 specified by the design data sets and the performance of a second product version thereby specified.

For this purpose, the relevant set SL1, SL2 or SL3 is supplied with the design data sets DR1 and DR2 as input data. From the input data DR1 and DR2, output data O1 and O2 are derived and output by the relevant set SL1, SL2 or SL3. In the present exemplary embodiment, the product specifications E1 and E2 are additionally fed into the set SL3 as input data.

The output data O1 and O2 are intended to reproduce in each case a respective actual performance value of a design variant specified by the design data sets DR1 or DR2 as closely as possible.

Training is generally understood to mean an optimization of a mapping of input data, here DR1, DR2 and, if necessary E1 and E2, to output data, in this case O1 and O2. This mapping is optimized according to predefined criteria during a training phase. Possible criteria to be used for this are, for example, a prediction error or reproduction error in the case of prediction models, a classification error in the case of classification models, and/or in the case of control models, a deviation of an optimized control action. As a result of the training, model parameters, method parameters, network structures of neurons of a neural network and/or weights of connections between the neurons can be adjusted or optimized in such a way that the criteria are satisfied as fully as possible. The training can thus be understood as an optimization problem. A plurality of efficient optimization methods are available for such optimization problems. In particular, genetic optimization methods, gradient descent methods, back propagation methods and/or particle swarm optimizations can be used.

In the present case, the training should take advantage of the fact that similar product versions have similar interdependencies or correlations between design data sets and performance values. By training a common machine learning module for different but similar product versions, common interdependencies or correlations can usually be learned in a very efficient manner. In addition, interdependencies or correlations that differ in different product versions can be efficiently mapped by product version-specific machine learning modules. In this way, an efficient, so-called transfer learning can be implemented, in which training results or training data from previous product versions are used for a current product version to be produced, in this case PV1.

The different sets SL1, SL2 and SL3 of machine learning modules make it possible to select those of the sets SL1, SL2 or SL3 that are particularly suitable for the respective training conditions, depending on the amount of available training data or product specifications.

The examples of sets SL1, SL2 and SL3 illustrated in FIG. 3 are described in more detail below:

In set SL1, the machine learning module LG_1 covering all product versions that is common to both product versions implements a Gaussian process and/or a Bayes model, while the product version-specific machine learning modules L1_1 and L2_1 each implement a linear regression model. Design data sets DR1 and DR2 are fed into the common machine learning module LG_1 as input data. An output signal OS of the common machine learning module LG_1 derived from the input data DR1, DR2 is fed into both the machine learning module L1_1 and the machine learning module L2_1. The output data O1 is derived from the output signal OS by the machine learning module L1_1 and the output data O2 is derived from the output signal OS by the machine learning module L2_1. Such a set of machine learning modules is often referred to as a coregionalization model.

The linear regression models L1_1 and L2_1 enable linear relationships between the performance values of different product versions to be learned in a highly efficient manner. Such linear regression models can also be modeled by relatively few parameters, the optimization of which in many cases can be achieved even with a relatively small amount of training data. Thus, the set SL1 in the present exemplary embodiment is selected by the selection module SEL when the available training data amount is relatively small and, for example, falls below a predetermined threshold value.

In the present exemplary embodiment, set SL2 comprises an artificial neural network, in particular a multi-layer perceptron, as the machine learning module LG_2 common to the product versions. The product version-specific machine learning modules L1_2 and L2_2 are each designed as an artificial neural network consisting of one or more layers. The layers can be linear or non-linear. Design data sets DR1 and DR2 are fed into the common machine learning module LG_2 as input data. The common machine learning module LG_2 derives an output signal OS from this, which is fed into the machine learning module L1_2 as well as into the machine learning module L2_2. The output data O1 is derived from the output signal OS by the machine learning module L1_2 and the output data O2 is derived from the output signal OS by the machine learning module L2_2.

In contrast to set SL1, the product version-specific machine learning modules L1_2 and L2_2 also allow a non-linear relationship between the performance of different product versions to be modeled or reproduced successfully. The resulting greater flexibility, however, usually requires more modeling parameters than in the linear case. Set SL2 is therefore selected by the selection model SEL when a larger amount of training data is available or when this amount exceeds a predetermined threshold value.

In the present exemplary embodiment, set SL3 comprises the machine learning module LG_3 common to both product versions and the product version-specific machine learning modules L1_3 and L2_3. The machine learning modules LG_3, L1_3 or L2_3 can each be implemented by an artificial neural network and/or by a Gaussian process. Unlike sets SL1 and SL2, set SL3 can also explicitly process product version-specific product specifications, in this case E1 and E2, and model them with respect to their correlation with design data sets and/or performance values.

Design data sets DR1 and DR2 are fed as input data into the common machine learning module LG_3, which derives an output signal OS therefrom and feeds this into both machine learning modules L1_3 and L2_3. Furthermore, product specifications E1 are fed as additional input data into the machine learning module L1_3 and product specifications E2 are fed as additional input data into the machine learning module L2_3. Output data O1 is derived and output from the output signal OS and product specifications E1 by the machine learning module L1_3. Similarly, output data O2 is derived and output from the output signal OS and the product specifications E2 by the machine learning module L2_3. In many cases, correlations between product specifications, design data sets and performance values can be identified and learned due to the additional consideration of the product version-specific product specifications E1 and E2 by the product version-specific machine learning modules L1_3 and L2_3. However, due to the additional differentiation possibilities offered by product specifications E1 and E2, more training data is usually required for efficient training than for training the other sets SL1 and SL2. The set SL3 is therefore selected by the selection module SEL if product version-specific product specifications, in this case E1 and E2, are present and a quantity of training data exceeds a predetermined threshold value.

Instead of or in addition to the sets SL1, SL2 and SL3, one or more other sets of machine learning modules may be provided, which are operated in an analogous manner. In addition, a respective set or machine learning module may also comprise a Bayesian neural network, a recurrent neural network, a convolutional neural network, an autoencoder, a deep learning architecture, a support vector machine, a k-nearest-neighbor classifier and/or a decision tree.

For the present exemplary embodiment, it is assumed that a large amount of training data is available and thus a number of training data sets determined by the selection module SEL exceeds a threshold value provided for the set SL3. Where the selection module SEL also determines that product specifications E1 and E2 exist for both product versions and relate to common product parameters, set SL3 is selected by the selection module SEL—as further illustrated in FIG. 2. Accordingly, the design data sets DR1 with product specifications E1 and the design data sets DR2 with product specifications E2 are specifically forwarded to the selected set SL3 as input data by the selection module SEL. The output data O1 and O2 are derived and output from input data DR1, E1, DR2 and E2 by set SL3 as described above.

The output data O1 is then compared with the performance values P1 and the output data O2 is compared with the performance values P2 and a deviation D is determined. In particular, Euclidean distances |O1-P1| and |O2-P2| between the output data O1 and the performance values P1, as well as between the output data O2 and the performance values P2, can be calculated. The deviation D can thus be calculated, for example, as the sum of these distances according to D=|O1-P1|+|O2-P2|, as a weighted sum or as another combination of individual deviations.

As indicated in FIG. 2 by a dashed arrow, the deviation D is fed back to the set SL3. Based on the fed back deviation D, the machine learning modules LG_3, L1_3 and L2_3 contained in set SL3 are jointly trained to minimize the deviation D. To perform such minimization, a plurality of efficient numerical methods are available, such as gradient descent methods, back propagation methods, particle swarm optimizations and/or genetic optimization methods.

By minimizing the deviation D, the machine learning modules LG_3, L1_3 and L2_3 of set SL3 are trained to predict, for specified design data sets DR1 or DR2 and product specifications E1 or E2, the corresponding performance values P1 or P2 for design variants of both product versions by their output data O1 or O2.

The machine learning module LG_3 covering all product versions makes it possible to learn the commonalities between different product versions in an efficient manner. In contrast, differences between the product versions can be represented by the product version-specific machine learning modules L1_3 and L2_3.

If one of the other sets SL1 or SL2 is selected by the selection module SEL instead of set SL3, the training can obviously be performed in an analogous manner.

FIG. 4 illustrates the trained design system DS when generating a performance-optimized design data set ODR. For this purpose, a plurality of synthetic design data sets DR1 is generated by a generator GEN of the design system DS, each of which specifies a design variant of the first product version PV1 to be produced. The generation is at least partially randomly induced.

The synthetic design data sets DR1 are fed from the generator GEN into the selection module SEL. In addition, product specifications E1 for the first product version PV1 are also supplied to the selection module SEL. The selection module SEL then selectively feeds the synthetic design data sets DR1 and product specifications E1 into the selected and trained set SL3. The synthetic design data sets DR1 are fed to the common machine learning module LG_3 as input data. The resulting output signal OS of the common machine learning module LG_3 and the product specifications E1 are then fed as input data into the machine learning module L1_3 specific to the first product version PV1 to be produced. The output data O1 derived from this by the machine learning module L1_3 is output and fed into an optimization module OPT of the design system DS. The synthetic design data sets DR1 are also fed to the optimization module OTP.

The optimization module OPT derives a performance-optimized design data set ODR from the synthetic design data sets DR1, depending on the supplied output data O1, i.e., on the predicted performance values. For example, the synthetic design data set for which the highest performance value O1 is predicted can be selected as the performance-optimized design data set ODR. Alternatively, the performance-optimized design data set ODR can be interpolated from multiple synthetic design data sets with the highest or with particularly high predicted performance values O1.

The performance-optimized design data set ODR derived from the synthetic design data sets DR1 is then output to control the production system PS, as described in connection with FIG. 1, for producing the optimized product version PV1.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A computer-implemented method for controlling a production system for producing a first product version based on design data sets of the first product version and a second product version, the method comprising:
a) reading in a plurality of product version-specific training data sets, each of which comprises a design data set, which specifies a design variant of a respective product version, and a performance value quantifying a performance of the design variant;
b) feeding the design data sets into a machine learning module covering all product versions;
c) feeding an output signal of the machine learning module covering all product versions into both a first product version-specific machine learning module and also a second product version-specific machine learning module; wherein
the machine learning modules are jointly trained so that output data of the first machine learning module reproduces the performance values of the first product version and output data of the second machine learning module reproduces the performance values of the second product version;
e) generating a plurality of synthetic design data sets, which are fed into the trained machine learning module covering all product versions;
f) feeding the resulting output signal of the trained machine learning module covering all product versions into the trained first machine learning module; and
g) depending on the resulting output data of the trained first machine learning module, deriving a performance-optimized design data set from the synthetic design data sets, which is output for producing the first product version.

2. The method as claimed in claim 1, for a plurality of design data sets, a performance value for the design variant specified by the respective design data set is determined by simulation, and that, together with the respective predicted performance value, a respective design data set is used as a training data set.

3. The method as claimed in claim 1, wherein
first product specifications, to be fulfilled by the first product version, and second product specifications, to be fulfilled by the second product version, are read in,
that during the joint training of the machine learning modules, the first product specifications are fed into the first machine learning module and the second product specifications are fed into the second machine learning module, and that when the resulting output signal is fed into the trained first machine learning module, the first product specifications are also fed into the trained first machine learning module.

4. The method as claimed in claim 1, wherein the machine learning module covering all product versions implements a Gaussian process and the product version-specific machine learning modules each implement a linear regression model.

5. The method as claimed in claim 1, wherein the machine learning modules each comprise a neural network.

6. The method as claimed in claim 1, wherein multiple sets of machine learning modules, each with a machine learning module covering all product versions, and two product version-specific machine learning modules are provided, that a number or quantity of available training data sets is determined, and that depending on the determined number or quantity, one of the sets is selected for the implementation of the training and for deriving the performance-optimized design data set.

7. The method as claimed in claim 6, further comprising checking whether product specifications are available for the first and for the second product version, and that, if the result of the check is positive, a set is selected, into product version-specific machine learning modules of which product specifications are to be fed.

8. A system for controlling a production system for producing a first product version based on design data sets of the first product version and a second product version, configured for implementing a method as claimed in claim 1.

9. A computer program product comprising a computer readable hardware storage device having computer readable program code stored therein, said pros n code executable by a processor of a computer system to implement a method as claimed in claim 1.

10. A machine-readable storage medium having a computer program as claimed in claim 9.
